(19) United States
(12) Patent Application Publication
(10) Pub. No.: US 2014/0315611 A1
(43) Pub. Date: Oct. 23, 2014

(54) System and Method for Providing a Scalable Configurable Modular Collaborative Word-Based Game Platform and Infrastructure

(71) Applicants: Igor Litinsky, Austin, TX (US); Marina Litinsky, Austin, TX (US)

(72) Inventors: Igor Litinsky, Austin, TX (US); Marina Litinsky, Austin, TX (US)

(21) Appl. No.: 14/255,951

(22) Filed: Apr. 17, 2014

Related U.S. Application Data
(60) Provisional application No. 61/812,835, filed on Apr. 17, 2013.

(51) Int. Cl. A63F 13/00

(52) U.S. Cl. CPC A63F 13/005
USPC 463/9

(57) ABSTRACT

In various alternate exemplary embodiments and implementations thereof, the inventive Collaborative Word-based Puzzle Game system and method (hereinafter referred to as the “CWPG Platform”), is operable to enable two or more players, engaging in a game session, to incrementally create and solve their own word-based puzzle (e.g., such as a crossword puzzle) during round by round gameplay, wherein during each round at least one first player, during their turn, generates a word-based puzzle element (having a at least one solution clue and a solution point value) which is then presented to at least one second player for attempted solution thereof during their turn, such that, for each gameplay round, a certain number of points (determined in accordance with at least one predefined scoring rule), are awarded to either: (a) the at least one second player upon successful solution thereof, or (b) to the at least one first player if the at least one second player fails to successfully solve the word-based puzzle element presented thereto during the at least one first player's turn that round. The at least one player that accumulates the most points at the end of gameplay wins the corresponding game session. In various exemplary embodiments thereof, the inventive CWPG Platform and related infrastructure(s) may comprise many additional gameplay elated and non-gameplay related novel capabilities, functions and features.

### FIELD OF THE INVENTION

The present invention relates generally to multi-player puzzle-based word games, and more particularly to systems and methods for providing and enabling various embodiments of a new type of a collaborative multi-player word-based puzzle game platform and infrastructure that enable two or more players to incrementally create and solve their own word-based puzzle during round by round gameplay.

### SUMMARY OF THE EXEMPLARY EMBODIMENTS OF THE PRESENT INVENTION

At the outset it should be noted that in accordance with the system and method of the present invention, various exemplary embodiments of the novel CWPG Platform and related infrastructure(s) may be readily implemented and deployed, in whole, or in part, via various types of data processing systems ranging from mobile/portable communication/computing devices (e.g., smart phone, tablet, pad, e.g.) application programs or “Apps”, and Web-based application programs/Apps (e.g., via HTML5, Java, Flash, or equivalent platforms), to various console game systems, embedded and/or downloadable game “channels” or applications in media playback/display devices (e.g., such as in internet-enabled TVs, cable/satellite set-top boxes, and media streaming devices (e.g., Apple TV, Nexus, Globe, Roku, etc.), and other types of game applications (such as stand-alone dedicated device games, game kiosks, etc.).

Furthermore, in various exemplary embodiments thereof, the inventive CWPG Platform and related infrastructure(s) may be deployed and implemented as multi-player software gaming applications (and/or application modules/objects), and related gameplay environments, that may be integrated into, and provided through, one or more dedicated, and/or 3^{rd} party, Internet websites and/or portals (such as, for example, through one or snore of the various social networking platforms (e.g., Facebook, Google+, Twitter, etc.).

Furthermore, the various embodiments of the system and method of the present invention may comprise at least one configurable modular infrastructure component that is not directly involved in gameplay, but that is rather operable to enhance the players' gameplay experience, provide players with numerous gameplay environment-related and other options.

Advantageously, the CWPG Platform and related gameplay, technical and business methodologies, infrastructure(s), and various elements thereof:
(a) are operable to provide a variety of optimal gameplay experiences for collaborative word-based puzzle games in various languages;
(b) are operable to maximize gameplay interest and player retention, and to optionally provide a wide range of additional gameplay-related and peripheral features and functions:
(c) are operable, in exemplary embodiments thereof in which, the word-based puzzles are crossword puzzles, to conduct gameplay drawing on at least one of:
   (i) internal “approved” words/questions resource sets, that may optionally be automatically improved and enhanced over time based on active player participation, and/or on passive player utilization thereof.
   (ii) external public domain/creative commons/(or equivalent) words/questions resource sets, and/or
   (iii) one or more third party words/questions resource sets: (e.g., provided in connection with 3^{rd} party marketing/sponsorship/promotion programs, premium sets (e.g., a NYT crossword resource), etc . . . );
(d) can be readily scaled, configured, and adapted to comprise many additional in-game features (such as player-player social interaction in and out of play, especially with respect to in-game acquisition of hints, as well as other player-player gameplay interaction within a predetermined set of gameplay interaction rules);
(e) can be readily deployed in conjunction with various monetization/cross-promotion/marketing/advertising/sponsorship, and equivalent techniques selectively integrated into game sessions, and/or into gameplay, at various desired integration degree levels. For example, in a CWPG Platform game in which the word-based puzzle is a crossword puzzle, a sponsored, or otherwise themed, game session may comprise:
   (i) particular third party words/questions resource sets (from which the puzzle elements may be selected during gameplay may be specially configured to promote new content (movies, books, games, TV shows, music, etc.), and/or to promote new products or services (toys, luxury items, beverages, etc.), and/or
   (ii) promotion/marketing related in-game elements (such as marked crossword field cells that unlock content/product discounts/coupons/freebies for one or more players when activated during gameplay in accordance with at least one gameplay elements activation rule); and
4) may comprise non-gameplay infrastructure and components that enable and facilitate acquisition/retention/repackaging of completed word-based game (e.g., crossword) puzzles resulting from previously completed game sessions, and offering thereof to players as “products for value” via one or more sales approaches (e.g., individually, packaged, theme packaged, etc.), and via virtual or real currency or equivalents, to additionally enable players to use the CWPG Platform for conventional or semi-conventional word-based puzzle (e.g., crossword) gameplay.

Thus, while there have been shown and described and pointed out fundamental novel features of the inventive system and method as applied to preferred embodiments thereof, it will be understood that various omissions and substitutions and changes in the form and details of the devices, systems, user interfaces, gameplay rules and methods illustrated, and in their operation may be made by those skilled in the art without departing from the spirit of the invention. For example, it is expressly intended that all combinations of those elements and/or method steps which perform substantially the same function in substantially the same way to achieve the same results are within the scope of the invention.

### OVERVIEW OF EXEMPLARY ADVANTAGEOUS NOVEL CAPABILITIES, FUNCTIONS, AND FEATURES OF THE SYSTEM AND METHOD OF THE PRESENT INVENTION

In various alternate exemplary embodiments and implementations thereof, the inventive CWPG Platform and related infrastructure(s), may optionally include, but are not limited to, one or more of the following advantageous capabilities, functions, and features, in various combinations thereof:
I. CWPG Platform Capabilities, Functions, and Features for Any Word-Based Puzzle Game
   (1) Gameplay/Game Environment Option: The CWPG Platform may incorporate multi-level support for “tokens” or equivalent virtual currency that will enable players to access, activate, and/or benefit from, various game environment and/or gameplay options (e.g., to gain clues or other assistance in solving puzzle elements during gameplay), to modify the game environment in and/or out of gameplay (change colors, add aesthetic elements to game screen, etc.), to purchase content offered in the game environment (such as complete single-player puzzle sets) etc.). The tokens may be acquired in various ways, that may include, but that are not limited to, one or more of the following:
a) purchased through real-world currency;
b) earned during gameplay (through winning games, gaining in-game rewards, etc.);
c) awarded for engaging in incentivized game sessions (e.g., playing in sponsored game sessions); and/or
d) awarded for consenting to view advertizing/promotional content in and/or out of gameplay, etc . . .
   (2) Gameplay Option: Gameplay may occur in various predetermined languages, related game environment may also be provided in a corresponding selected language.
   (3) Gameplay Option: game sessions gray be played with at least one computer generated (non-human) opponent.
   (4) Gameplay Option: game sessions may be between more than two players (e.g., many-on-many, one-on-many, many-on-one, team play, etc.
   (5) Pre-Game Session Opponent Selection Options: selection of an opponent based on of least one opponent parameter (e.g., opponent's skill level, relative skill levels, age, location, relationship to the choosing player (e.g., “find an available opponent among my Facebook friends and/.or Google+ circle members), etc.), selection of an opponent based on the player-chosen word-based puzzle game (e.g., crossword puzzle) theme.
   (6) Gameplay/Game Environment Option: advertising/marketing/promotional content may be integrated into one or more aspects of the game experience (optionally reduced, controlled, and/or eliminated through purchase of a premium version of the CWPG Platform application.
   (7) Gameplay/Game Environment Option: Players may be provided with multiple logins, in order to share a particular data processing system on which the CWPG Platform is deployed. Once logged in, players can sign on and off by simply entering a password or a PIN without the need to log in and out for every game session set, thus enabling several players to utilize the same device to access CWPG Platform game sessions.
   (8) Gameplay Option: enable players to download one or more available gameplay support resources (e.g., word/definition resources/dictionaries for crossword puzzle games) to enable offline play.
   (9) Gameplay Rules Options: game sessions cam be terminated in various ways, for example, if a player forfeits his turn X times, Y times in a row, both players forfeit their turns, or f no moves have been made for Z days, etc . . .
II. CWPG Platform Capabilities, Functions, and Features for at Least One Exemplary Embodiment in Which the Word-Based Puzzle Game is Crossword Puzzle-Based

### (10) Exemplary Gameplay Parameters for at Least One CWPG Platform Crossword Puzzle Embodiment:

a) During a multi-round turn-based game session, opposing players incrementally create their own crossword puzzle through gameplay.
b) Players place words (as puzzle elements) on a game board vertically or horizontally, with various additional words following the initially placed cord, being selected so that the words cross one or more other words previously placed on the board and share at least one letter therewith.
c) During the first turn of each round, one player provides at least one clue for their chosen word to heir opponent (e.g., by choosing a word definition from one or more provided word/definition source(s) (e.g., a dictionary), or by writing, or otherwise generating their own solution clue,
d) The other player attempts to solve each word puzzle element based on the corresponding due provided by their opponent (and optionally selectively supplemented with one or more additional solution assistance resources that may be offered to the player within the game environment).
e) The solving player implements their solution by composing the solved word in its corresponding position on the game board by moving the letter tiles forming the word onto the game board.
(f) Each gameplay round, the players alternate taking turns choosing words, providing corresponding clues, and solving the words, thus creating their own crossword puzzle by the conclusion of the full gameplay session.
g) Each solved word earns the solving player a certain amount of points, determined in accordance with at least one scoring rule.
h) By the end of the game session the player with the highest umber of earned points wins the game.
   (11) Gameplay Option (Crossword Puzzle): The crossword grid may be of any practical desired size (for example, selectable size, gameplay device-specific size, size based on available display device, etc. (e.g., a grid can comprise squares in any of the following configurations 13×13, 15×15, 17×17, etc . . .
   (12) Gameplay Option (Crossword Puzzle). Word clues may be provided in any media content form, such as through one or more of: pictures, sounds, audio clips, video clips, etc.
   (13) Gameplay Option (Crossword Puzzle): A player may receive notification If the provided word clue is generated by their opponent, if the word provided for solution is not on an approved list.
   (14) Gameplay Option (Crossword Puzzle): The game may utilize a proprietary or modified word/definition resource that may be improved over time through active and/or passive player involvement (i.e., by players actively voting on/rating better/poorer definitions, by tracking frequency of selections of certain provided and/or layer-generated definitions, tracking solution rates, etc.
   (15) Gameplay Option (Crossword Puzzle): A player may receive notification if the provided word clue is generated by their opponent, if the word provided for solution is not on an approved list.
   (16) Gameplay Option (Crossword Puzzle): Players may be provided with various selectively usable gameplay options to assist them in word solution (made available for free and/or through use of a predetermined number of tokens), for example: shuffling letter tiles (to solve the word), eliminating some of the letter tiles to make it easier to solve the word, revealing one or more letters of a word puzzle.
   (17) Gameplay Option (Crossword Puzzle): Additional game features include, but are not limited to: game board tiles that carry surprises (e.g., bonus points, token awards, etc.), chat features, various in-app purchases, etc.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A data processing system for providing gameplay functionality and infrastructure for two r more players comprising:
a data processing system component operable to enable two or more players, engaging in a game session, to incrementally create and solve their own word-based puzzle during round by round gameplay, wherein during each round at least one first player, during their turn, generates a word-based puzzle element, having a at least one solution clue and a solution point value, which is then presented to at least one second player for attempted solution thereof during their turn, such that, for each gameplay round, a certain number of points (determined in accordance with at least one predefined scoring rule), are awarded to either: (a) the at least one second player upon successful solution thereof, or (b) to the at least one first player if the at least one second player fails to successfully solve the word-based puzzle element presented thereto during the at least one first player's turn that round, wherein the at least one player that accumulates the most points at the end of gameplay wins the corresponding game session.
